(19) United States
(12) Patent Application Publication
(10) Pub. No.: US 2026/0166469 A1
(43) Pub. Date: Jun. 18, 2026

(54) CONTINUOUS-MOTION DIRECT AIR CAPTURE SYSTEM

(71) Applicant: Global Thermostat Operations, LLC, Brighton, CO (US)

(72) Inventors: Peter Eisenberger, Princeton, NJ (US); Eric Ping, Thornton, CO (US); Miles Sakwa-Novak, Arvada, CO (US); Jed Pruett, Atlanta, GA (US); Robert Klepper, Arvada, CO (US); Sarah Wyper, Denver, CO (US)

(73) Assignee: Global Thermostat Operations, LLC, Brighton, CO (US)

(21) Appl. No.: 19/425,879

(22) Filed: Dec. 18, 2025

Related U.S. Application Data
(63) Continuation of application No. 18/001,124, now Pat. No. 12,533,623.
(60) Provisional application No. 62/705,061, filed on Jun. 9, 2020.

(51) Int. Cl. B01D 53/04; B01D 53/00; B01D 53/06; B01J 20/28; B01J 20/34; C01B 32/55

(52) U.S. Cl. CPC B01D 53/0446; B01D 53/005; B01D 53/0431; B01D 53/06; B01J 20/28042; B01J 20/3466; C01B 32/55; B01D 2253/342; B01D 2256/10; B01D 2256/12; B01D 2257/504; B01D 2258/06; B01D 2259/40088

(57) ABSTRACT

A system and a method for continuously separating carbon dioxide from gas mixtures, utilizing a continuous loop of porous monoliths which support a sorbent within its pores. Continuously exposing a portion of the continuous loop of monoliths to a flow of gas mixture containing a minor proportion of carbon dioxide, to adsorb carbon dioxide from the flow. The loop passes through a sealed regeneration and carbon dioxide capture assembly located astride a portion of the loop, and which is capable of sealingly containing a monolith in relative movement through the assembly. The assembly chamber comprises a plurality of separately sealed zones, including at least one zone for purging oxygen from the monoliths,-a subsequent zone for heating the monolith to release the adsorbed carbon dioxide, and another cooling zone for cooling the monolith prior to reentering the adsorption portion of the loop where it is exposed to oxygen.

### CROSS-REFERENCE TO RELATED APPLICATIONS

This application is a continuation of U.S. application Ser. No. 18/001,124, filed Dec. 8, 2022, which is a national stage filing under 35 U.S.C. § 371 of International Application Serial No. PCT/US2021/036696, filed Jun. 9, 2021, which claims the benefit of U.S. Provisional Application Ser. No. 62/705,061, filed Jun. 9, 2020. The entire contents of these applications are incorporated herein by reference in their entirety.

### TECHNICAL FIELD

This patent application comprises a novel and inventive approach to the direct air capture (DAC) of carbon dioxide. More specifically, the present invention contemplates a system that is capable of continuously, substantially non-stop, capturing of carbon dioxide from any number of sources such as, without limitation, ambient (i.e., atmospheric) air, flue gases from sources such as fossil fuel combustion, and combinations of carbon dioxide-containing gases which may or may not include ambient air.

### BACKGROUND OF THE INVENTION

Direct Air Capture, or DAC, is a term known to describe technologies that can remove CO2 from ambient air and create a concentrated CO2 product stream that can be sold, utilized, upgraded, or sequestered underground. This is described in detail in a report published by the National Academies of Sciences in 2019 titled “Negative Emissions Technologies and Reliable Sequestration”. A primary challenge for direct air capture of carbon dioxide is to achieve relatively low cost, high efficiency air contact. The present invention contemplates use of relatively shallow honeycomb monolith contactors (˜15 cm deep) that permit low pressure drops (100^{th}'s of Pa) at gas approach velocities of 3-5 ms-1, while maintaining a relatively high geometric surface area per unit volume. This is described in U.S. Pat. No. 9,937,461. This permits minimizing costs for gas processing by allowing the use of draft fans for inducing gas movement during the CO2-removal process. Monolith contactors formed with open through channels are washcoated with porous oxide films along the channels. The adsorbent itself is, of course, critical to the efficacy of the process, as it sets the productivity levels and regeneration requirements. In the present invention, numerous types of monoliths, washcoats, and sorbent types have been used. Examples of such materials are described in U.S. Pat. Nos. 8,801,834, 9,457,340, US 20120216676, and US 20170080376A1. A current example of a preferred sorbent material is low molecular weight (˜800 Da), highly branched poly(ethyleneimine) (PEI) that is incorporated into pores within a monolith. This allows for high volumetric amine loadings (i.e. amine sites/adsorbent volume). Solid amine adsorbents interact with CO2 via a chemical adsorptive mechanism, resulting in high CO2 adsorption capacities at very low CO2 partial pressures and high selectivity to CO2over other components of air, such as water in the form of humidity. The presence of humidity in air improves the efficiency of the adsorbent.

Desorption is carried out more rapidly than adsorption. Desorption can be performed by contacting the CO2 laden monolith with steam, for example, so as to heat it and release the bound CO2. This rapid process can occur 10 times faster than the adsorption step. This is described in U.S. Pat. No. 9,937,461. This adsorption-to-desorption time ratio is accounted for with plant designs that incorporate a greater number of adsorption beds performing the CO2 adsorption step than those performing a desorption step. In previous designs, this was achieved by utilizing multiple monolith panels arranged in an endless loop that are physically moved through a regeneration area. This is described in U.S. Pat. No. 10,512,880. When stopped in the regeneration area, the panels seal against the regeneration box whereby a series of cycle steps are executed to perform the regeneration. Each cycle step serves a specific function to heat the monolith, collect the desorbed CO2, and cool the monolith prior to reintroduction to airflow to reduce its oxidation rate. In this process, the mechanical movement involves the need to periodically start, stop, and finely position monolith panels during each regeneration interval, which can take place in less than a few minutes. One of the disadvantages of a DAC system according to earlier embodiments with start/stop functionality resides in the mechanical challenges that can limit cycle times, lead to high wear and mechanical stress, as well as decreased reliability.

In the current invention, separate, discrete process cycle steps are replaced with a more optimal, continuous movement zonal plant design that utilizes the equivalent of multiple adsorption beds. It is contemplated according to at least one embodiment of the present invention that process plants are to be designed so that for every equivalent bed of monolith that is regenerating, multiple others (presently nine other beds of monolith are preferred) are subject to ambient airflow adsorbing CO2. This allows the capital associated with the plant process equipment to be substantially used all the time, thereby reducing the CAPEX per tonne of CO2 produced. In prior approaches, there is a challenge because the process equipment (boiler, pumps etc.) must service multiple monolith beds in a rapid, cyclic fashion. This has been addressed by physically moving monoliths in and out of the regeneration area, while the air-treating monoliths are stopped.

### BRIEF SUMMARY OF THE INVENTION

A primary object of one embodiment of the present invention is to provide a continuous motion direct air capture system that will capture CO2 from the air or other mixture of gases containing CO2 and will produce a continuous stream of high purity CO2 product. The system of the present invention will result in decreased costs of DAC for the operating costs and capital expense for the system.

The present invention further demonstrates an advanced DAC process designed to reduce the cost of capturing CO2 from the ambient air and other mixture of gases containing carbon dioxide, as well as the energy burden associated with the capture process. This inventive next-generation process comprises a continuous system and process, as compared to one or more earlier-generation cyclic batch processes. The use of a continuous process allows plant components to operate at steady state, thereby reducing the relative complexity of starting and stopping a movement system, eliminating the need for rapid-cycling and high-cycling valves, and significantly reducing the required utility capacity of the plant. These advantages lead to greater plant reliability, lower instantaneous utility demands and thus costs, and lower capital expense. By current estimates, the CAPEX per tonne of CO2 can be reduced by at least 33% with lower operating expense and enhanced reliability.

The present invention contemplates not only a novel process capable of continuous, substantially non-stop, capturing of carbon dioxide after adsorption, but also one or more novel embodiments of associated apparatus for generating or carrying out the novel process. Thus, practice of the novel process or method of this invention may be carried out by one or more types of apparatus and shall be considered as coming within the scope of the present invention.

The system and process according to the present invention utilizes a substantially continuous relative movement and treatment of a series of sorbent-containing monoliths, in the form of a continuous loop of sorbent monoliths subject to a plurality of process zones; specifically, the continuous loop of monoliths is formed of lines of small monoliths, preferably placed immediately adjacent each other, both vertically and horizontally. This forms, preferably, a substantially continuous wall of monoliths. Specifically, the continuous loop of monoliths is formed of lines of small monoliths, preferably placed immediately adjacent each other, both vertically and horizontally. This forms, preferably, a substantially continuous wall of monoliths. Process zones in this context mean zones of fluid flow through the monolith at a specific temperature, pressure, and composition to either adsorb CO2 from a dilute mixture, or to be regenerated to release and capture relatively pure CO2. Each process zone serves a specific and distinct function that creates a process cycle for the sorbent passing through it, as part of the regeneration and CO2-capture processes. These process zones replace process cycle steps utilized in the batch process. In different embodiments, the sorbent monoliths in the loop remain stationary and the apparatus containing the regeneration process zones moves, or the sorbent monoliths move, around the loop, passing through the regeneration apparatus; either embodiment thus providing the equivalent relative movement and the equivalent function while passing through the stationary regeneration apparatus.

Suitable monoliths and sorbents for use in this invention are described for example in copending, commonly owned International Applications Nos. PCT/US2021/023473 and PCT/US2020/61690. The description of the monoliths in copending PCT/US2021/023473 is hereby incorporated by reference as if fully repeated herein. The continuous monolith wall could possibly be formed of one or a few very large, extruded pieces, but as shown in commonly owned International Application No. PCT/US2021/023473, they could be more easily assembled from relatively small monolithic blocks, as if building a brick wall.

### BRIEF DESCRIPTION OF THE SEVERAL VIEWS OF THE DRAWING

FIG. 1 is a Schematic showing a conceptual plan view of a continuous DAC process system having a four-zone regeneration box.

FIG. 2 is a Schematic showing a conceptual plan view of a continuous DAC process, having a three-zone regeneration box.

FIG. 3 is a Schematic showing a conceptual plan view of the regeneration apparatus with a three-zone process basis.

FIG. 4 shows a conceptual schematic plan view of the three-zone regeneration apparatus with a heat recycle stream.

FIG. 5 is an isometric schematic picture of apparatus for carrying out the DAC processes shown in FIGS. 1-4, showing a moving regeneration apparatus moved by a spoke powered from a central pivot.

FIG. 6 is a schematic cross sectioned elevation view of the apparatus with central pivot of FIG. 5.

FIG. 7 is a schematic isometric top view of apparatus for carrying out a DAC process showing a top mounted multi-fan arrangement.

FIG. 8 is a schematic isometric top view of apparatus for carrying out a DAC process showing an interior-side mounted multi-fan arrangement for each sorption zone.

FIG. 9 is a schematic isometric top view of apparatus for carrying out a DAC process showing an exterior-side mounted multi-fan arrangement for each sorption zone.

FIG. 10 shows a schematic isometric top view of apparatus for carrying out a DAC process showing a single top mounted fan for the entire loop.

FIG. 11 shows a diagrammatic plan view of apparatus for carrying out a DAC process showing a single top mounted fan, as in FIG. 10.

FIG. 12 shows a schematic isometric top view of apparatus for providing a foam roller seal assembly to seal monoliths within a regeneration box, or apparatus.

FIG. 13 shows an exploded view of the foam roller seal assembly of FIG. 12.

FIG. 14 shows a schematic of a labyrinth seal assembly that creates a boundary between two zones.

FIG. 15 shows a top-down view of a labyrinth seal assembly.

FIG. 16 depicts a Concentric loop concept for operating a plurality of monolith loops.

FIG. 17 shows a multi-regeneration apparatus concept. A monolith loop (1700) is serviced by fans (1703) placed and more than one regeneration apparatus (1706). Each regeneration apparatus (1706) moves relative to the monolith at a constant rate.

FIG. 18 shows a flue gas injection adsorption zone immediately preceding a four-zone regeneration.

FIG. 19 depicts a non-circular track concept.

### DETAILED DESCRIPTION OF THE INVENTION

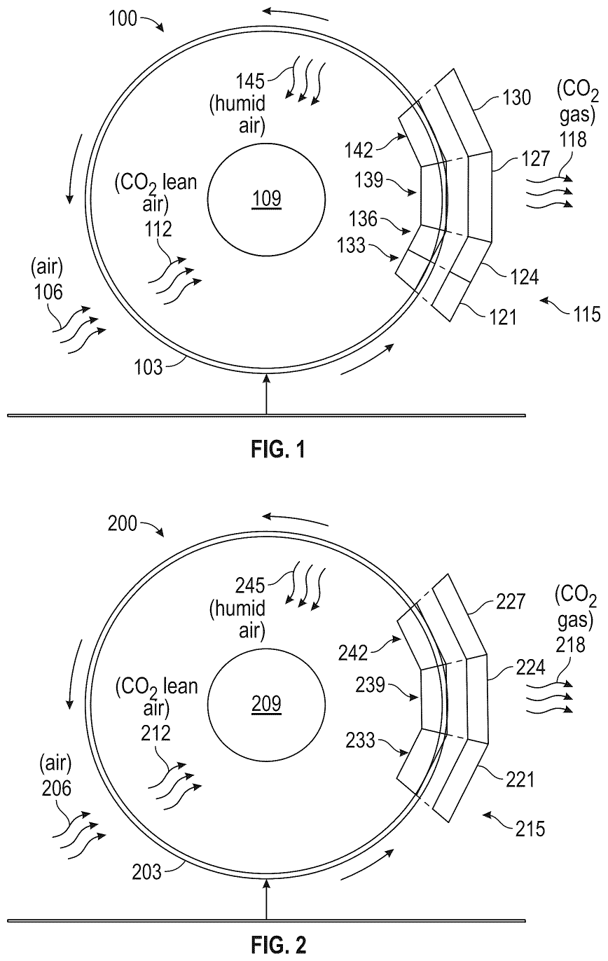

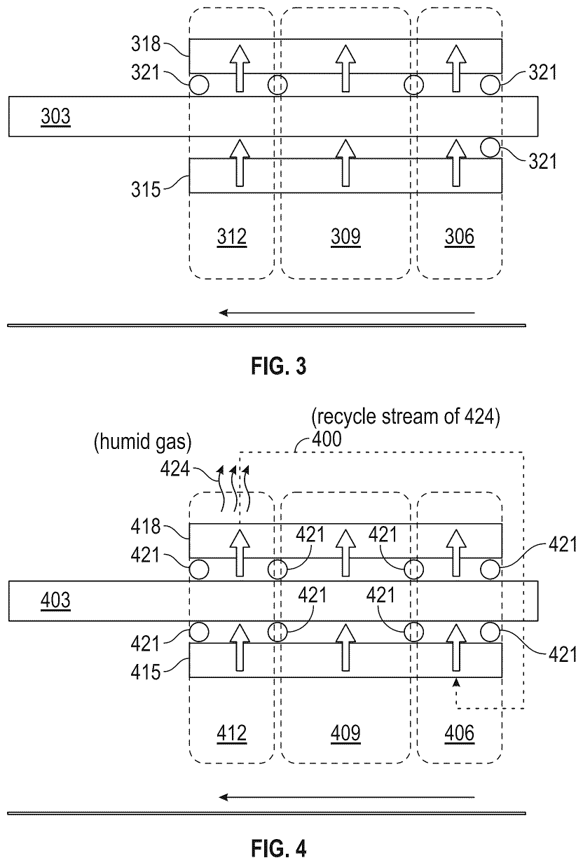

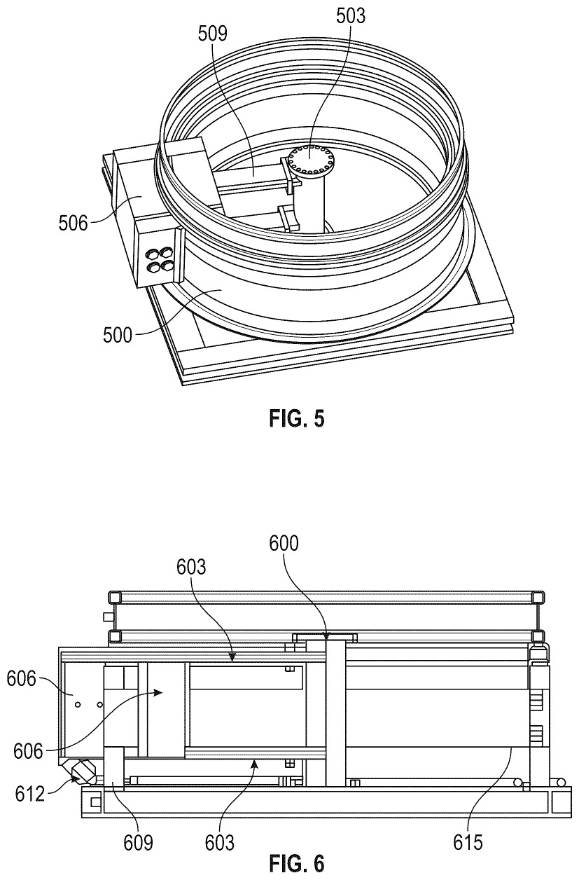

The system and process according to one embodiment of the present invention utilizes a substantially continuous relative movement of a series of sorbent monoliths, forming in one embodiment a continuous loop of sorbent monoliths subjected to a plurality of process zones; as shown in FIG. 1, FIG. 2, FIG. 3, and FIG. 4, the loop of monoliths move substantially at a constant rate past sources of a flow of air and through process zones for regenerating the sorbent. Process zones here mean zones of fluid flow through the monolith at a specific temperature, pressure, and composition. Each process zone serves a specific and distinct function that creates a process cycle for the sorbent passing through it, as part of the adsorption and regeneration and CO2-capture processes. These process zones replace process cycle steps utilized in the batch process. In another embodiment shown in FIG. 5 and FIG. 6, the loop of sorbent monoliths remain stationary and the regeneration apparatus (Chamber 506, in FIG. 5), containing the regeneration process zones moves, thus providing the equivalent relative movement and the equivalent function.

Regeneration of the sorbent, by desorption of CO2 is performed by a temperature swing delivered by condensation of, e.g., saturated steam directly onto the monolith surface, raising the temperature to ˜70-130°. The zones within the regeneration apparatus, located before and after this desorption zone, serve to both maintain sorbent lifetime and to achieve relatively higher CO2 purity, as shown in FIG. 1, FIG. 2, FIG. 3, and FIG. 4. The core sequence of a regeneration process cycle can include the following steps:
i. reduction in O2 concentration surrounding the monolith in the first zone of the regeneration box;
ii. direct contact condensation of steam to heat the monolith and desorb CO2 in a central zone of the regeneration box; and
iii. cooling of the monolith by evaporation of condensed water on its surface in the final zone of the regeneration box.

Further, internal heat integration can be accomplished by recycling the stream resulting from steps ii) or iii) and including it in step i) or by the addition of a step (and a zone) between step i) and ii) as shown in FIG. 4. Internal heat integration is beneficial because it can reduce the total energy required per cycle, thereby reducing the cost of CO2 capture by the process. A continuous design is advantaged over a batch process design in using internal heat integration in that process fluids can be directly recycled within the same monolith plants. In previous embodiments, process fluids could be shared for heat integration only between sister monolith plants.

Primary fluid inputs to the system of this invention are ambient air, one or more inert gases, such as, without limitation, N2 and makeup water. Exiting the plant are CO2-lean air containing water vapor, a N2/air mixture containing water vapor, and product CO2. CO2 will exit the plant boundaries at slightly elevated temperature and pressure saturated with water. For certain applications, further purification of CO2 may be utilized using established methods as needed. Previously consumable process fluids such as inert gasses can be recycled internally according to the present invention, such as to form a nearly closed loop to limit overall consumption of treatment fluids and reduce costs.

The continuous process according to the present invention maintains a basic movement concept, but by operating the process continuously, eliminates the need for starting and stopping of the system. Additionally, the proposed invention embodiment will allow process equipment to deliver fluids at steady state, rather than intermittently. This will result in reduced costs (i.e., smaller scale equipment, lower pressure steam generation, and lower cost vacuum pumps).

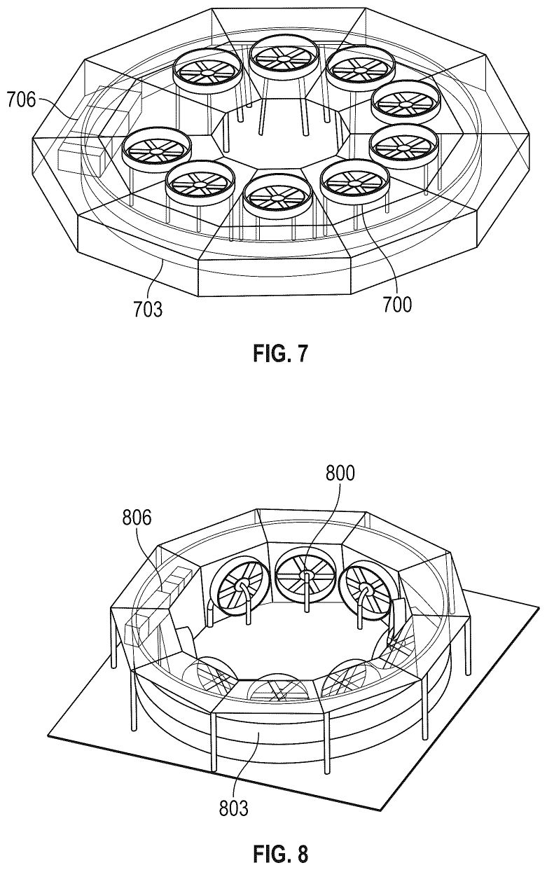

A plurality of what are herein referred to as “Regeneration Zones” or regeneration stages, are utilized according to this invention for the collection of CO2 adsorbed during exposure to airflow. The Regeneration Zones are carried out within a regeneration and carbon dioxide harvest assembly, enclosed within a sealed chamber 115 and 215 in FIGS. 1 and 2, respectively, and as 506, 606, and 1906 in FIGS. 5, 6, and 19, respectively, and as 706, 806, and 906 in FIGS. 7-9, respectively.

In the later-generation continuous process described here, some of these regeneration stages can be carried out with an inert gas, a recycled product CO2 stream, or excluded altogether. Critically, CO2 is being neither adsorbed nor desorbed in steps i) or iii), so minimizing their cumulative step times is important for maximizing productivity. Step ii) is done at constant pressure and CO2 is removed as it is evolved by a vacuum pump or blower. This approach produces a steam/CO2 mixture that, after passing through a condenser/separator, gives concentrated a CO2 product of up to 95% purity.

There are many ways of implementing the general process description that is provided above. Examples of different possible embodiments are described below:

### Details of Drawing Figures

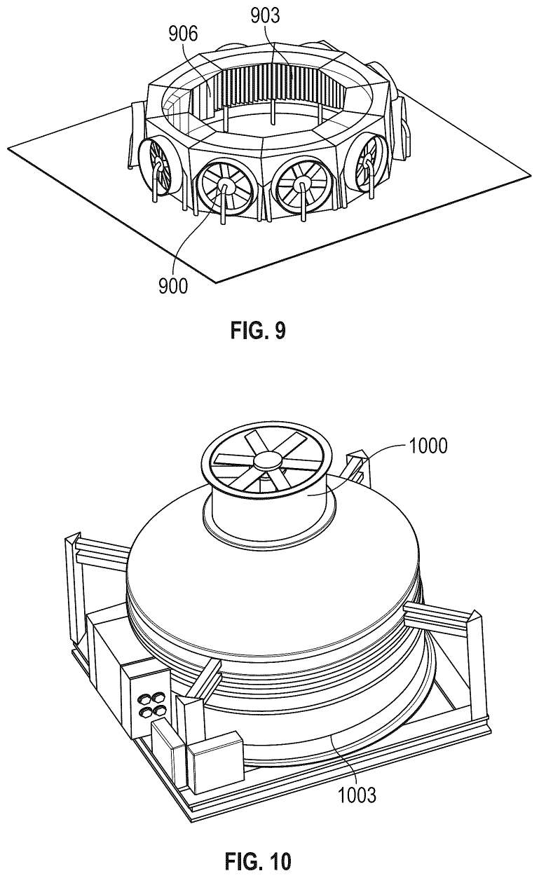

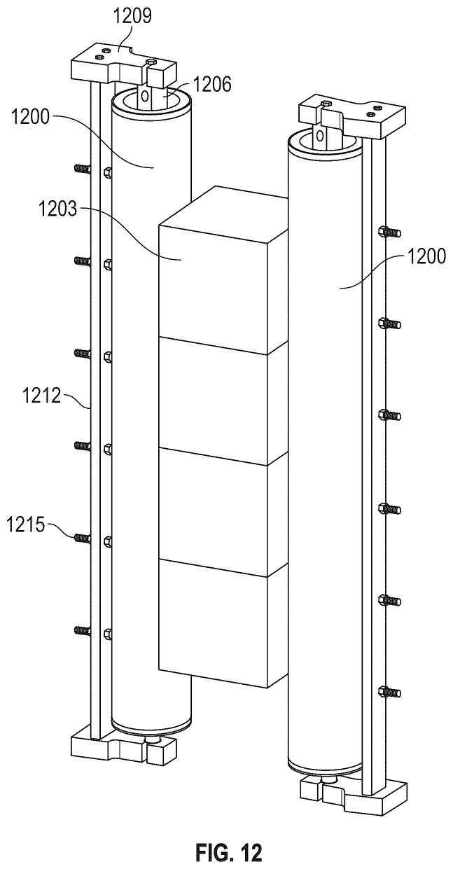

FIG. 1 is a Schematic showing a conceptual plan view of a continuous DAC process, having a four-zone regeneration box. Each monolith (100) supports a CO2 sorbent, preferably in a mesoporous layer within open channels formed through each monolith, and moves in a direction around a track (103) where air (106) passes through each monolith via a fan or set of fans (109). Air enters the monolith channels (100), CO2 is adsorbed by the sorbent in the monolith, and CO2-lean air (112) exits the monolith and is discharged from the fan or set of fans as exemplified in FIGS. 9-11. Each monolith (100) in turn enters the sealed regeneration apparatus (115) and is regenerated, producing concentrated CO2 (118), through a set of zones (121) through (130). In this 4-zone process schematic, the first zone (121) is an inert gas purge (133) that removes any air from the monolith channels and pores; the second zone (124) is a rapid steam sweep (136) to remove the inert gas such as to allow for high purity CO2 production; the third zone (127) is the Regeneration and Harvest zone where steam is injected (139), condenses on the monolith, and CO2 is produced (118) and harvested for storage or further use; the fourth zone (130) is the cooling zone, where inert gas (142) is passed through the monolith channels to cool them prior to reintroduction to airflow. Humid air (145) exhausts from the monolith to further cool and dry as it reenters airflow. As the continuous monolith loop enters the chamber containing the regeneration and carbon dioxide harvest assembly, it passes between sealing members sealing off the interior of the chamber from the outside air. Many embodiments of such sealing members are available, two preferred examples of sealing members are shown in FIGS. 12-15. A pair of sealing members also separates each of the several zones within the regeneration and carbon dioxide harvest assembly chamber 115.

FIG. 2 shows a conceptual plan view of a three-zone continuous process. The monolith (200) moves in a direction around a track (203) where air (206) is drawn through it via a fan or set of fans (209). Air (206) enters the monolith (200), CO2 is adsorbed onto the monolith channel surfaces, and CO2-lean air (212) exits the monolith and is discharged from the fan or set of fans (209). The monolith enters the regeneration apparatus (215) and is regenerated, producing concentrated CO2 (218), through a set of zones (221) through (227). In this 3-zone process schematic, the first zone (221) is a gas purge (233) that removes O2 from the monolith channels. This can be performed by a variety of gas streams including N2, CO2, steam, flue gas, and mixtures of these gases. This zone serves to improve the material lifetime by preventing oxidation but also removes air that exists in the monolith channels that can reduce the purity of CO2 produced (218). The second zone (224) is the Regeneration and Harvest zone where steam is injected (239), condenses on the monolith, and CO2 is produced (218); the third zone (227) is the cooling zone, where inert gas (242) is passed through the monolith channels to cool them prior to reintroduction to airflow. Humid air (245) exhausts from the monolith to further cool and dry as it reenters airflow.

FIG. 4 shows a conceptual schematic plan view of a three-zone regeneration apparatus of FIG. 3 with a heat recycle stream 400. The monolith (303, 403) moves through the regeneration zones (306, 406) through (312, 412), where process fluids are delivered. Process fluids flow from the delivery side (315, 415) of the desorption apparatus to the gas collection side (318, 418). The zones are separated from one another by seals (321, 421) to isolate process fluids in one zone from the fluids in another zone from the exterior both at the entrance and exit from the assembly chamber 115 and 215, respectively, as shown in FIGS. 1 and 2. The monolith moves in a direction such that the first zone (306, 416) is the purge zone; the second zone (309, 409) is the regeneration and harvest zone, and the third zone (312, 412) is the cooling zone. Hot humid gas (424) exiting the third zone (412) is recycled to the first zone (406) to both perform the function of zone one but also to preheat the monolith before it enters zone two.

FIG. 5 shows the concept of moving the regeneration unit about a center pivot. Monoliths (500) are arranged as a ring with a center axis point (503) at the center. The regeneration apparatus (506) rotates around the monolith (500) to deliver the regeneration conditions to each monolith in turn. The center axis point (503) is connected to the regeneration apparatus (506) by pivot arms (509). Process fluid piping is routed to and from the regeneration apparatus through the pivot arms (509). The continuous nature of the monolith loop is clearly depicted by the exterior and interior circumferential walls of the monolith loop as displayed in FIGS. 5, 8-10, and 16, 17 and 19. The continuity of the monolithic loop is best displayed by the schematic diagram of FIGS. 3, 4.

FIG. 6 is a schematic cross sectional, elevation view of the apparatus with a central pivot or axis point of FIG. 5. Process piping routes in and out of the central pivot (600) via the pivot arms (603) to supply the process fluids to the regeneration apparatus (606). The center pivot (600) allows for rotation of large rotary union joints for fluid piping. The regeneration apparatus (606) is driven about the track (609) with industrial guide wheels (612). The monoliths (615) are mounted above the regeneration unit's track system and the regeneration unit (606) encloses both sides of the monoliths (615).

FIG. 7 shows a top mounted fan configuration for the systems of FIGS. 1-4. In this design, fans (700) are mounted in the horizontal plane (to rotate about a vertical axis, on the top face of the carbon dioxide capture plant. The fans (700) move air by induced draft, pulling air in through the monoliths (703) ejecting air out the top. The fans (700) are arranged along the perimeter of the monolith (703) track. A portion of the track is designated to the regeneration apparatus (706).

FIG. 8 shows an interior side mounted fan configuration. In this design, fans (800) are mounted in the vertical plane on top of the carbon capture plant. The fans (800) move air by induced draft, pulling air in through channels of the monoliths (803) and ejecting air inwards towards the center of the plant. The fans (800) are arranged along the perimeter of the monolith (803) track. A portion of the track is designated to the regeneration apparatus (806).

FIG. 9 shows the exterior side mounted fan configuration. In this design, fans (900) are mounted in the vertical plane along the exterior perimeter of the carbon capture plant. The fans (900) move air by induced draft, pulling air in through the channels of the monoliths (903) and ejecting air out radially away from the plant. The fans (900) are arranged along the perimeter of the monolith (903) track. A portion of the track is designated to the regeneration apparatus (906).

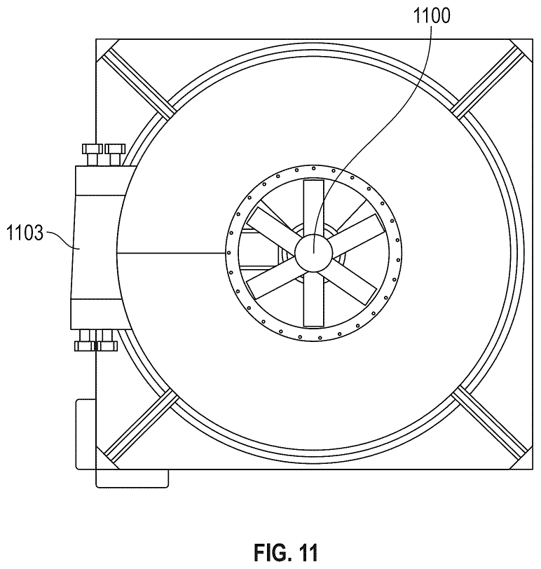

FIG. 10 shows the single top mounted fan configuration. In this design the fan (1000) is mounted in the horizontal plane on the top structure of the direct air carbon capture (DAC) plant. The fan (1000) moves air by induced draft, pulling air in through the channels of the monolith (1003), and ejecting air out upwards away from the plant.

FIG. 11 shows a plan view of the single top mounted fan arrangement, as exemplified by FIG. 10. The fan (1100) is in the center of the roofing material or deck, and the regeneration apparatus (1103) occupies a portion of the monolith track.

FIG. 12 shows a schematic of two roller seal assemblies which together create one embodiment of a seal, forming a single boundary between two zones of a regeneration apparatus, or between the first and last zones of the regeneration apparatus and the exterior of the regeneration chamber. The roller seal is comprised of a foam material (1200) that wraps around a steel pipe. The roller seals press against the monolith (1203) face to form a physical seal. The seal assembly is spring-loaded to maintain compression.

As shown, the monolith loop is formed of stacked individual small monolith (1203) blocks. The seal assembly has an internal hex rod (1206) that runs through the length of the pipe, and which is mounted with set screws to blocks (1209) on the top and bottom of the assembly. Those blocks (1209) are then mounted to a tensioning bar (1212). The tensioning bar (1212) is then in turn mounted to inner or outer walls of a regeneration unit with shoulder screws (1215) that can slide through their mounting holes in the tensioning bar (1212) and compress springs that reside along the shoulder (1215) of the screw.

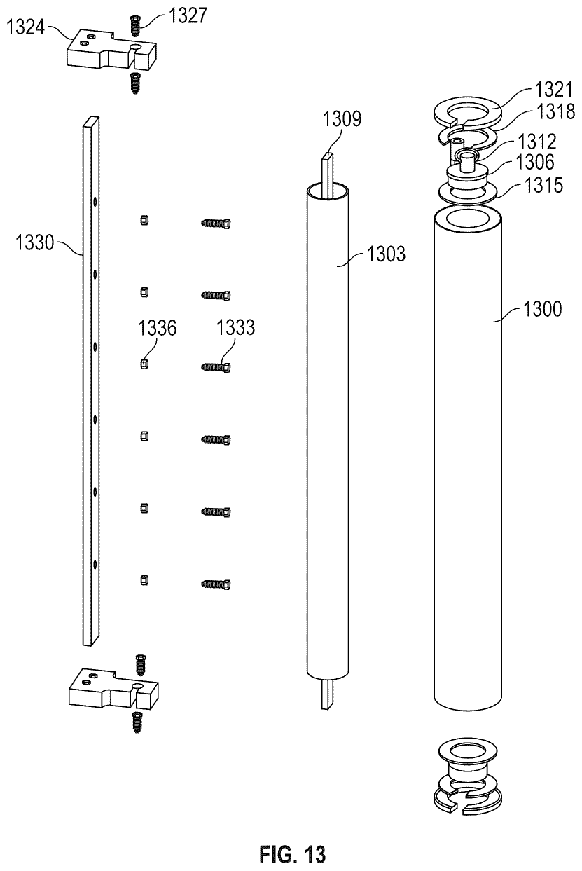

FIG. 13 shows an exploded view of the polymer foam, e.g., silicone, roller seal assembly of FIG. 12 and all of its components. The foam (1300) is the main sealing element and wraps around a solid steel pipe (1303). Conveyor bearings (1306) are pressed into each end of the steel pipe (1303), and a hex rod (1309) runs through the length of the seal. The conveyor bearings (1306) work by rotating freely around the internal rod as long as the rod is held stationary. A magnetic non-contact radial encoder (1312) is mounted to the top conveyor bearing (1306). There is a steel washer (1315) adhered to the top and bottom faces of the silicone foam (1300). Needle thrust bearings (1318) are pressed into a Delrin gasket (1321), which is mounted to a regeneration unit and as the foam roller (1300) rotates the thrust bearings (1318) make contact with the washer (1315) and create the minimum gap possible that also allows for movement. The internal hex rod (1309) is mounted to the top and bottom blocks (1324) held with a set of 4 screws (1327). The top and bottom mounting blocks (1324) are mounted to a tensioning rod (1330) again with a set of screws. The tensioning rod (1330) is then in turn fixed to a regeneration unit's internal or external walls with shoulder screws (1333). These shoulder screws (1333) allow the seal assembly to move when compressing the springs (1336), which are coupled with the shoulder screws (1333). This compression ensures that the roller seal is always making good contact with the monoliths. Other embodiments can achieve this same result.

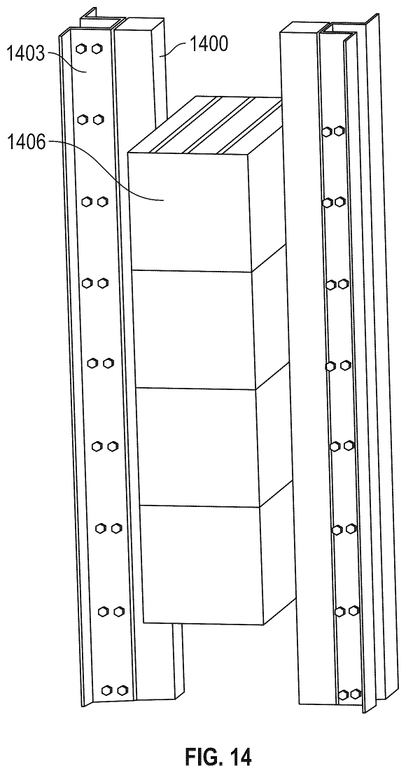

FIG. 14 shows an elevation view of another example of a seal, a so-called labyrinth seal assembly that creates a boundary between two zones. The seal is made up of a series of wiper blades (1400) that are bolted together and mounted to the internal or external walls of a regeneration unit with two angle brackets (1403). The wiper blades are positioned very close to the monolith (1406).

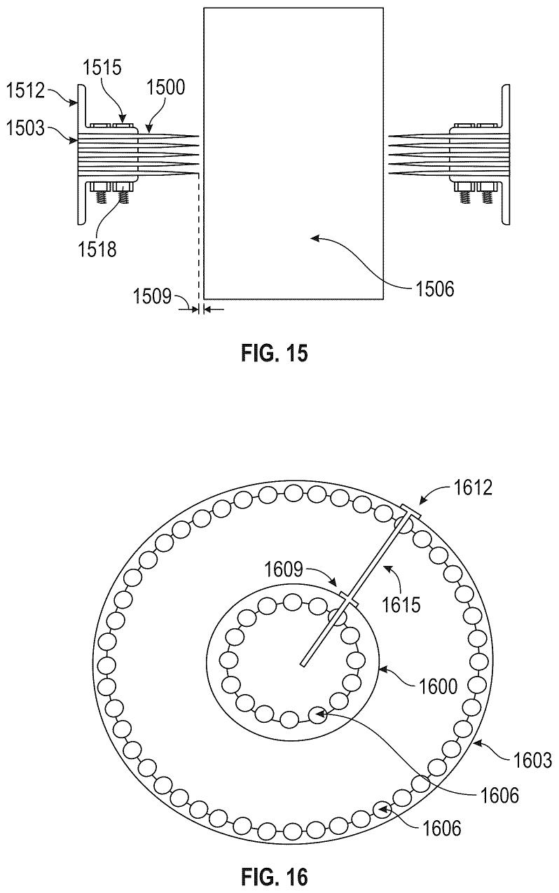

FIG. 15 shows a top planar view of the labyrinth seal assembly. A series of wiper blades (1500) and spacers (1503) comprise the sealing elements. The wiper blades (1500) do not directly contact the monolith (1506). There remains a gap of distance (1509) that can range between 1/16^{th} inch to 1 inch depending on the allowable tolerances of the system. The series of wiper blades (1500) and spacers (1503) are bolted together in between two pieces of angle iron (1512) with bolts (1515) and locking nuts (1518).

FIG. 16 depicts an example of a concentric loop concept for powering a plurality of monolith loops. Here, an inner loop (1600) of monoliths is placed inside of an outer loop (1603) of monolith. Each loop has fans (1606) located around its perimeter in a top mounted, side mounted, interior, or exterior orientation. The inner loop (1600) has a regeneration apparatus (1609), and the outer loop (1603) has a regeneration apparatus (1612). A spoke (1615) connects both regeneration apparatuses to continuously move both loops.

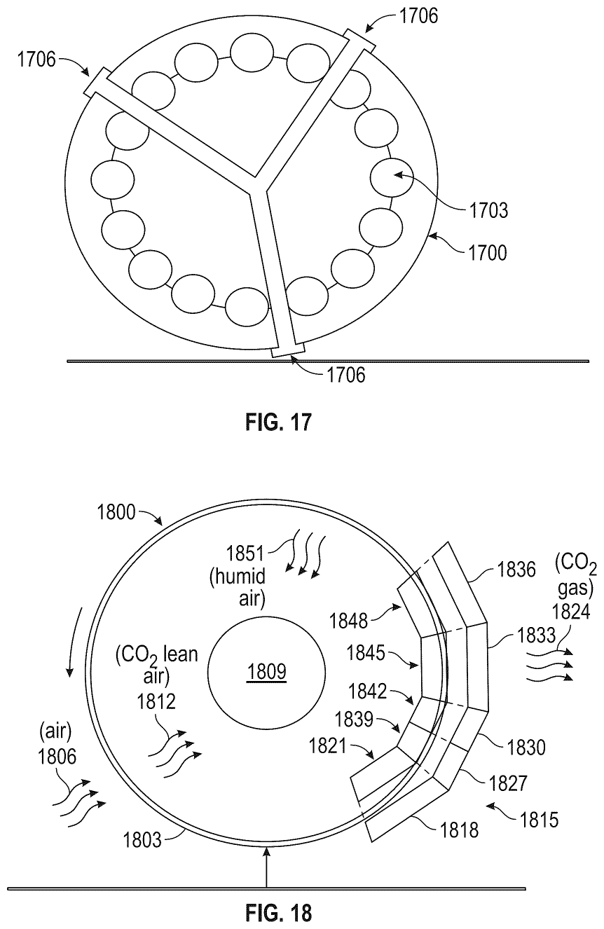

FIG. 17 depicts diagrammatically one embodiment of a loop of monoliths serviced by a plurality of regeneration boxes. The air through the monolith channels on the loop (1700) is moved by fans located within the loop by fans (1703) placed adjacent each monolith. Each of the several regeneration apparatus (1706) moves relative to the monolith at a constant rate, either by the monoliths being moved around the loop, or by the regeneration apparatus each being moved around the loop.

FIG. 18 shows a conceptual plan view of another embodiment of the four-zone continuous regeneration process with an immediately preceding adsorption zone where the monolith is treated with a flue gas injection just prior to its entering the regeneration location. The prior zones as the monolith (1800) moves in a direction around a track (1803) where air (1806) is drawn into each monolith, for example by a fan or set of fans (1809). Air enters the monolith (1800), CO2 in the air is adsorbed onto the monolith surface, and CO2-lean air (1812) exits the monolith and is discharged from the fan or set of fans, e.g., FIGS. 8-11. Before a monolith (1800) enters the regeneration apparatus (1815), it enters a flue gas injection zone (1818), where flue gas (1821) is injected into the monolith channels and further CO2 is adsorbed onto the monolith. The monolith (1800) enters the regeneration apparatus (1815) and is regenerated, producing concentrated CO2 (1824), through a set of zones (1827) through (1836). In this 4-zone process schematic, the first zone (1827) is an inert gas purge (1839) that removes O2 from the monolith channels; the second zone (1830) is a rapid steam sweep (1842) to remove the inert gas such as to allow for high purity CO2 production; the third zone (1833) is the Regeneration and Harvest zone where steam is injected (1845), condenses on the monolith, and CO2 is produced (1824) and harvested; the fourth zone (1836) is the cooling zone, where inert gas (1848) is passed through the monolith channels to cool them prior to reintroduction to airflow. Humid air (1851) exhausts from the monolith to further cool and dry as it reenters airflow.

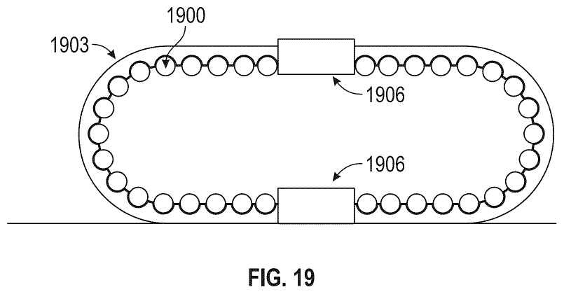

FIG. 19 another embodiment including a non-circular track concept. A loop of monoliths is arranged in a non-circular shape, where the monoliths move around the perimeter where fans (1900) draw air through them. The monolith loop (1903) enters a regeneration apparatus (1906), where CO2 is produced. There can be one or more regeneration apparatuses (1906) depending on the movement speed.

### Further Detailed Discussion Of Invention

### Four Zone Process Design

In one embodiment of the current invention, the sorbent regeneration is performed with four zones. Zone 1 can employ a first gas, such as, without limitation, N2, sweep to reduce the oxygen level in the monolith such that the temperature can be raised. Zone 2 will employ a second gas, such as, without limitation, steam or CO2, to sweep the first gas from the monolith to enable a high purity CO2 product to be collected. Zone 3 will provide steam injection at a controlled rate to heat the sorbent and produce a CO2/Steam mixture. Zone 4 employs a flow of a third gas, or a mixture of inert gas and air, through the monolith channel to cool it before returning to airflow. When a monolith exits Zone 4, it will move into an airflow zone where air is drawn through the open channels by an induced draft fan located, for example, at the center of the structure and exhausting upwards.

See FIG. 1, which illustrates the continuous DAC process according to the present invention. CO2 is adsorbed within the monolith during airflow as it moves around the ring before entering Zone 1 again. The diameter of the ring determines the scale of the unit, and the relative arc length of Zones 1-4 to that of the airflow zone equals the ratio of desorption to adsorption times. It is important to emphasize here that the arc of each zone may be modified or eliminated without departing from the scope and spirit of the present invention.

### Three Zone Process Design (Steam Purge)

In one embodiment of the current invention, the sorbent regeneration is performed with three zones. This is shown in FIG. 2. A three zone embodiment results in a faster regeneration process with less operating expense than a four zone embodiment. Zone 1 employs a rapid steam sweep to purge the channels of air. This steam sweep is performed with a rapid velocity of steam such that little steam condenses on the interior surface of the monolith so as to not heat the sorbent. Zone 2 will provide steam injection at a controlled rate to heat the sorbent and produce a CO2/Steam mixture. Zone 3 employs a flow of an inert gas such as N2, or a mixture of inert gas and air to a targeted O2 level, through the monolith channel to partially cool it before returning to airflow.

### Three Zone Process Design (CO2 Purge)

In another embodiment of the current invention, the sorbent regeneration is performed with three zones. This is shown in FIG. 2. A three zone embodiment results in a faster regeneration process with less operating expense than a four zone embodiment. In one embodiment, Zone 1 employs a CO2 sweep to purge the channels of air. This CO2 sweep is performed with a rapid velocity of CO2 such that little additional CO2 adsorbs onto the monolith. Zone 2 will provide steam injection at a controlled rate to heat the sorbent and produce a CO2/Steam mixture. Zone 3 employs a flow of an inert gas such as N2, or a mixture of inert gas and air to a targeted reduced O2 level, through the monolith channel to partially cool it before returning to airflow.

### Flue Gas Injection Design

In one embodiment of the current invention, a flue gas, or other CO2-enriched gas, is injected at a targeted velocity such as to adsorb additional CO2 from the flue gas onto the monolith, in an adsorption zone immediately preceding the regeneration zones. This is shown in FIG. 18. The velocity and zone size can be altered to optimize the additional adsorption of CO2 such as to prevent CO2 originally in the flue gas from escaping, or breaking through, the back of the monolith; or the velocity and zone size can be altered to maximize the CO2 uptake per unit time. The flue gas can also be used to purge the channels of residual air. The flue gas can provide preheating to the monoliths through its sensible heat, as well as through exothermic adsorption heating, reducing the overall energy requirements. Zone 1 of the regeneration box will provide for further flushing out of the monolith. Zone 2 will provide steam injection at a controlled rate to finish heating the sorbent and produce a CO2/Steam mixture. Zone 3 employs a flow of an inert gas such as N2, or a mixture of inert gas and air to a targeted O2 level, through the monolith channel to partially cool it before returning to airflow.

### Center Driven Movement of Monoliths

In one embodiment of the current invention, the monolith wheel is moved through the regeneration zones by mechanical means driven from the center of a circular wheel. This is shown in FIG. 5 and FIG. 6. In this embodiment a central drive powers the movement by arms, or spokes, that reach from the center to the edge of the ring. The monoliths are held in frames that can be moved around the circumference of the track by wheels or another low friction system. The spokes, or arms, attach to the monolith frames at the top or bottom to drive them around the edge of the system and through the air and regeneration zones. One or more mounted fans draw air evenly through the monoliths. Process fluids are delivered to and from the process zones via tubes routed through static piping such as would be found in any process plant.

### Edge Drive Movement of Monoliths

In one embodiment of the current invention, the monolith loop is moved through the regeneration zones by mechanical means driven from the edge of a circular wheel or other shaped system. The monoliths are held in frames that can be moved around the circumference of the track on wheels or another low friction support. In this embodiment one or more motors located around the inside or outside edge of the monolith loop engage a fin or other item attached to the monolith panels. The motor can engage the fin by a wheel, gear, or other rotating means. One or more mounted fans draw air evenly through the monoliths. Process fluids are delivered to and from the process zones via tubes routed through the steel arms. The tubes each have rotation joints to permit movement

### Center Driven Movement of Regeneration Box

In one embodiment of the current invention, the regeneration assembly is moved around the monolith loop by mechanical means driven from the center of a circular wheel, as can also be shown by FIGS. 5 and 6, where the mechanical, tube-filled arm moves the regeneration box around the loop of stationary monoliths. In this embodiment a central drive powers the movement by arms, or spokes, that reach from the center to the edge of the ring. The monoliths are held in frames that are static and cannot be moved. The regeneration assembly is mounted such that it can be moved around the track on wheels or another low friction system. The spokes, or arms, attach to the regeneration assembly at the top or bottom to drive it around the edge of the system. One or more mounted fans draw air evenly through the monoliths. Process fluids are delivered to and from the regeneration process zones via tubes routed through the steel arms. The tubes each have rotation joints to permit movement, without leaking fluids.

### Edge Drive Movement of Regeneration Box

In one embodiment of the current invention, the regeneration assembly is moved around the monolith loop by mechanical means driven from the edge, or perimeter, of the monolith loop. In this embodiment one or more motors located at the inside or outside edge of the regeneration assembly engage a fin or other item attached to the regeneration assembly. The motor can engage the fin by a wheel, gear, or other rotating means. The monoliths are held in frames that are static and cannot be moved. The regeneration assembly is mounted such that it can be moved around the track on wheels or another low friction system. One or more mounted fans draw air evenly through the monoliths. Process fluids are delivered to and from the process zones via tubes routed through the steel arms. The tubes each have rotation joints to permit movement.

### Top Mounted Fan Arrangement

In one embodiment of the current invention, fans are mounted around the perimeter of the monolith ring with their blades oriented parallel to the ground. This is shown in FIG. 7, FIG. 10 and FIG. 11. This arrangement, referred to as ‘top mounting’, mimics conventional cooling towers. The fans are arranged relative to the monolith loop such as to induce airflow through the monoliths rather than force airflow through the monoliths. In this embodiment, air is ejected upwards away from the plant after it passes through the monolith and fan area. In this embodiment, either the monoliths or the regeneration box can be the moving component of the plant. In this embodiment, the fan speeds and size can be optimized, adjusted, changed, or different from one another at different positions along the monolith loop to optimize performance and energy use of the DAC process.

### Side Exterior Mounted Fan Arrangement

In one embodiment of the current invention, fans are mounted around the perimeter of the monolith ring with their blades oriented perpendicular to the ground and are positioned on the exterior of the monolith loop. This is shown in FIG. 9. This arrangement is referred to as ‘side exterior mounting’. The fans induce airflow from interior to exterior of the monolith loop, across the monolith. In this embodiment, air is ejected outwards after it passes through the monolith and fan area. In this embodiment, either the monoliths or the regeneration box can be the moving component of the plant. In this embodiment, the fan speeds and size can be optimized, adjusted, changed, or different from one another at different positions along the monolith loop to optimize performance and energy use of the DAC process.

### Side Interior Mounted Fan Arrangement

In one embodiment of the current invention, fans are mounted around the perimeter of the monolith ring with their blades oriented perpendicular to the ground and are positioned on the interior of the monolith loop. This is shown in FIG. 8. This arrangement is referred to as ‘side interior mounting’. The fans induce airflow from exterior to interior of the monolith loop, across the monolith. In this embodiment, air is ejected inwards after it passes through the monolith and fan area. In this embodiment, either the monoliths or the regeneration box can be the moving component of the plant. In this embodiment, the fan speeds and size can be optimized, adjusted, changed, or different from one another at different positions along the monolith loop to optimize performance and energy use of the DAC process.

### Non-Circular Track

In one embodiment of the current invention the monolith loop is non-circular. This is shown in FIG. 19. The monolith loop can be any shape with smooth corners and a radius of curvature such as to facilitate smooth continuous movement of either the regeneration assembly or the monolith loop to deliver process conditions to each of the monoliths in order. The monolith loop shape can be symmetric or non-symmetrically shaped. It can be regular or irregularly shaped.

### Multiple Regeneration Box Single Ring Arrangement

In one embodiment of the current invention, there are multiple regeneration assembly areas on a single monolith loop. This is shown in FIG. 17. Monolith loops that are very large can be equipped with any number of regeneration areas, such that the ratio of total regeneration area to non-regeneration area is the same as an embodiment with only a single regeneration area. In this way, the monolith loop relative speed, whether moving the regeneration box or the monoliths can be controlled to a slow, safe, and efficient rate while the total output of the plant can increase. Further, process fluids can be shared between regeneration areas to reduce the total cost of the plant.

### Concentric Ring Arrangement

In one embodiment of the current invention, multiple monolith loops can be placed concentrically within one and other. This is shown in FIG. 16. In this embodiment, the amount of CO2 produced from a given area of land can be increased by avoiding large open spaces in the middle of a loop of monolith loop.

### Foam Roller Seal Regeneration Box

In one embodiment of the current invention, the zones in the regeneration box are created by direct contact roller seals that sealingly separate the zones from one another, and from the exterior of the regeneration assembly. These seals are shown schematically in FIG. 3 and FIG. 4, and in detail in FIG. 12 and FIG. 13. In this embodiment, roller seals roll against the monolith face on both the gas inlet and outlet sides of the monolith. The roller seals compress slightly against the face of the monolith and rotate as the monolith passes through it to maintain contact. A full seal is formed by means of a wiper seal that contacts the roller seal in a position opposite where the roller seal contacts the monolith.

The seal is comprised of a solid tube that has a layer of soft material adhered to the exterior surface. The soft material can be a foam material. The soft material should compress against the face of the monolith by 1/16″ to 1″ to form the seal. The foam material can be made of silicone, EPDM, or another rubber material. The foam material can be open cell or closed cell but is preferably closed cell. The foam material can have a void fraction of between.

### Labyrinth Seal Regeneration Box

In one embodiment of the current invention, the zones in the regeneration box are created by non-contact labyrinth seals that separate the fluids from the process zones from one and other. This is shown in FIG. 14 and FIG. 15. These can also be used to seal the edges of the regeneration assembly from the air flow area. These labyrinth seals do not contact the face of the monolith, but rather create a very small gap between their tip and the monolith face. The labyrinth seals can be spaced from between 1/32″ to ½″ away from the monolith face to create a zone seal. Multiple labyrinth seals can also be used to create a single seal. A single labyrinth seal, or a set of labyrinth seals are placed on both sides of the monolith face to form one side of a seal. Further, two labyrinth seals placed close together on both sides of the monolith with a pressurized fluid running between them can form a blanketed labyrinth seal that adds additional sealing capacity to the regeneration zones.

An existing need that is satisfied by the present invention includes overcoming technical challenges associated with known direct air capture (DAC) processes. Such challenges include providing a system having the ability to process enormous volumetric flowrates of carbon dioxide-laden air, performing regeneration at low cost, and reducing overall capital costs to deliver these conditions. Further, costs can be exacerbated by relatively low reliability factors of some previous inventions. This currently unfulfilled need has created an opportunity seized by the inventors of the present invention for improving overall capture costs-especially capital costs and overall reliability.

As discussed above, a primary object of the present invention is to provide a continuous motion, as opposed to being operated in a discrete batchwise fashion, direct air capture system that will capture CO2 from the air and produce a >95% purity CO2product. The system of the present invention will result in decreased costs of DAC.

This invention seeks to advance DAC technology to a level not previously attained. Not only will this invention significantly advance the state of the art of DAC technology, but it will also significantly reduce the cost per ton of carbon dioxide captured and, optionally, being capable of sequestration.

Among the inventions disclosed herein, the present invention teaches a novel combination of inventive concepts, including a system, apparatus and methods of capturing carbon dioxide from ambient air as well as mixtures of gases, some of which include but are not limited to ambient air. In one embodiment of the present invention disclosed herein, carbon dioxide is captured using a rotating system, described in more detail above. In another embodiment of the invention, carbon dioxide is removed from a stream of gas that includes ambient air, combined flue gas from a fossil fuel combustion source.

In the past, it was known to use either a single unit containing both a sorption section open to the atmosphere and a regeneration capability utilizing the same unit but having valved conduits capable of switching between the source of ambient air i.e. the atmosphere, and a source of process heat steam, for example. With steam of preferably process heat is generally used in these carbon capture systems at temperatures of not greater than 120° Celsius and preferably below 100°, the operating costs for this system would be lowered.

This patent application provides examples in and of a system for continuously directly capturing carbon dioxide from ambient air and/or gases containing ambient air. Other examples will occur to persons who are skilled in the art, and all of same shall come within the scope of the present invention, as defined by the following claims.

1. (canceled)

2. A method, comprising:
capturing, via a sorbent, carbon dioxide from a gas, wherein at least a portion of the gas is ambient air;
reducing, in a first regeneration zone, an oxygen concentration the sorbent containing the captured carbon dioxide is exposed to;
heating, in a second regeneration zone, the sorbent to release at least a portion of the captured carbon dioxide from the sorbent; and
reducing, in a third regeneration zone, a temperature of the sorbent.

3. The method of claim 2, further comprising, after reducing the temperature of the sorbent, capturing, via the sorbent, additional carbon dioxide from the gas.

4. The method of claim 2, wherein the sorbent is moved from the first regeneration zone to the second regeneration zone, and subsequently from the second regeneration zone to the third regeneration zone.

5. The method of claim 2, wherein the oxygen concentration is reduced in the first regeneration zone using a purge gas.

6. The method of claim 5, wherein the purge gas includes at least one of N₂, CO₂, steam, and flue gas.

7. The method of claim 5, further comprising removing, in a fourth regeneration zone, at least a portion of the purge gas.

8. The method of claim 7, wherein the purge gas is removed with steam.

9. The method of claim 2, wherein the sorbent is heated in the second regeneration zone using steam.

10. The method of claim 2, further comprising inducing a flow of the gas via a fan or a set of fans.

11. The method of claim 2, wherein the gas is ambient air.

12. The method of claim 2, wherein the temperature of the sorbent is reduced in the third regeneration zone using an inert gas.

13. The method of claim 2, wherein the sorbent is supported by one or more monoliths.

14. The method of claim 13, wherein reducing the oxygen concentration in the first regeneration zone includes removing air from channels and/or pores of the one or more monoliths.
